(19) United States
(12) Patent Application Publication
(10) Pub. No.: US 2016/0254532 A1
(43) Pub. Date: Sep. 1, 2016

(54) ADHESIVE PASTING METHOD FOR LITHIUM ION BATTERY POLE PIECE

(71) Applicant: GUANGZHOU FULLRIVER BATTERY NEW TECHNOLOGY CO., LTD., Guangzhou, Guangdong (CN)

(72) Inventors: Shihua ZENG, Guangzhou (CN); Jiangping CHEN, Guangzhou (CN); Jiabao ZHU, Guangzhou (CN); Mingyi RONG, Guangzhou (CN)

(21) Appl. No.: 15/093,718

(22) PCT Filed: Sep. 24, 2014
(86) PCT No.: PCT/CN2014/087290

§ 371 Date: Apr. 7, 2016

(30) Foreign Application Priority Data
Oct. 8, 2013 (CN) 201310464312.3

(51) Int. Cl. H01M 4/139; H01M 10/058; H01M 4/04; H01M 10/0525; H01M 4/13

(52) U.S. Cl. CPC H01M 4/139; H01M 10/0525; H01M 4/13; H01M 4/04; H01M 4/0404; H01M 10/058; H01M 2004/028

(57) ABSTRACT

An adhesive pasting method for lithium ion battery pole piece, includes the steps of: (a) putting a hot melt adhesive ring in a pole piece cavity; (b) disposing a surface of a lithium ion battery pole piece with a paste composition downward so that the paste composition corresponds to a hollow part of the hot melt adhesive ring; (c) switching on the heating element to heat the pasting die-head to a pre-set temperature; (d) switching on the driver to drive the pasting die-head to move downward until the raised pasting surface presses against the lithium ion battery pole piece, thus causing an exterior surface of the hot melt adhesive ring to melt and adhere to the lithium ion battery pole piece; and (e) driving the pasting die-head to separate from the pole piece bottom die to obtain a hot melt adhesive ring-attached lithium ion battery pole piece.

### FIELD OF THE INVENTION

The present invention relates to an adhesive pasting method, and more particularly to an adhesive pasting method for lithium ion battery pole piece.

### BACKGROUND OF THE INVENTION

The present ultrathin lithium ion battery pole piece includes positive current collector and negative current collector. When positive pole piece is produced, the positive pole slurry is printed or sprayed uniformly on the middle part of positive current collector. While the peripheral part of positive current collector is reserved for adhesion sealing edge. Dry and roll the positive current collector, and clean the peripheral part of positive current collector reserved, a positive pole piece would be obtained. Then punch the hot melt adhesive for a hot melt adhesive ring, whose size corresponds to that of the peripheral part of positive current collector reserved. Conglutinate the hot melt adhesive ring to the peripheral part of positive current collector reserved and obtain a positive pole piece with hot melt adhesive ring. A negative pole piece with hot melt adhesive ring could be obtained in the same way. Said hot melt adhesive rings are used to bind the positive and negative pole piece together to produce battery.

Presently there are several major types of pasting apparatus for battery: 1. Adhesive pasting apparatus for battery pole piece, is a machine used for sticking protection tape on pole piece tab when the pole piece is welded to the pole piece tab to protect battery cells from the burr of pole piece tab and from the heat emitted by the pole piece tab during charge and discharge process. 2. Adhesive pasting apparatus for battery cells, is used to fix the battery cells by sticking adhesive tape after winding or laminating the battery cells, and then encapsidated the battery cells to protect them from scattering or damage. 3. Adhesive pasting apparatus for battery, is to paste double-sided adhesive on the battery, and then be put into a packing shell so that the battery was fixed in the packing shell without shaking. However, these machines couldn't realize the adhesive pasting of ultrathin lithium ion battery pole piece, therefore, the present adhesive pasting technology of ultrathin lithium ion battery pole piece can't guarantee the quality of pole piece, which greatly affects functional performance and limits the development of ultrathin lithium ion battery.

### SUMMARY OF THE INVENTION

The present invention provides an adhesive pasting method for lithium ion battery pole piece, which is easy to implement and solves technical problems of ultrathin lithium ion battery pole piece pasting.

In order to achieve the above purposes, the present invention provides an adhesive pasting method for lithium ion battery pole piece to be used by an adhesive pasting machine.

The adhesive pasting machine includes a pole piece bottom die, a pasting die-head, a controller, a rack, and a driver. The rack includes a rack platform and a pedestal. The pole piece bottom die is disposed in a bottom part of the pedestal; the pasting die-head is disposed in an upper part of the pedestal and driven by the driver; and the controller is disposed on the rack platform and electrically connected to the driver. The pole piece bottom die has a pole piece cavity configured to hold and position a pole piece. A lower part of the pasting die-head matches with the pole piece cavity so that a lower end of the pasting die-head is embedded into the pole piece cavity. A surface of the lower end of the pasting die-head has a closed and raised pasting surface, and the pasting die-head includes a heating element electrically connected to the controller.

The adhesive pasting machine may further includes two or more pole piece bottom dies disposed on a movable platform at the bottom part of the pedestal. The movable platform is electrically connected to the controller and performs under instructions of the controller horizontal movements or rotational movements, so that each of the pole piece bottom dies is moved around between a pasting station and a material loading station.

In an embodiment of the present invention, the adhesive pasting method for lithium ion battery pole piece includes the steps of:

(a) putting a hot melt adhesive ring in the pole piece cavity;

(b) disposing a surface of a lithium ion battery pole piece with a paste composition downward so that the paste composition of the lithium ion battery pole piece corresponds to a hollow part of the hot melt adhesive ring and that a lateral side of the surface of the lithium ion battery pole piece without any paste composition corresponds to an upper part of the hot melt adhesive ring;

(c) switching on the heating element to heat the pasting die-head to a pre-set temperature;

(d) switching on the driver to drive the pasting die-head to move downward, the pole piece bottom die to move upward, or the pasting die-head and the pole piece bottom die to move toward each other simultaneously, until the closed and raised pasting surface presses against the lithium ion battery pole piece, thus causing the heated pasting die-head to melt an exterior surface of the hot melt adhesive ring and allowing the hot melt adhesive ring to adhere to the lithium ion battery pole piece; and

(e) the driver driving the pasting die-head to separate from the pole piece bottom die to obtain a hot melt adhesive ring-attached lithium ion battery pole piece.

In another embodiment of the present invention, the adhesive pasting method for lithium ion battery pole piece includes the steps of:

(a) putting a hot melt adhesive ring in the pole piece cavity;

(b) disposing a surface of a lithium ion battery pole piece with a paste composition downward so that the paste composition of the lithium ion battery pole piece corresponds to a hollow part of the hot melt adhesive ring and that a lateral side of the surface of the lithium ion battery pole piece without any paste composition corresponds to an upper part of the hot melt adhesive ring;

(c) switching on the heating element to heat the pasting die-head to a pre-set temperature;

(d) switching on the driver to drive the pasting die-head to move downward, the pole piece bottom die to move upward, or the pasting die-head and the pole piece bottom die to move toward each other simultaneously, until the closed and raised pasting surface presses against the lithium ion battery pole piece, thus causing the heated pasting die-head to melt an exterior surface of the hot melt adhesive ring and allowing the hot melt adhesive ring to adhere to the lithium ion battery pole piece;

(e) the driver driving the pasting die-head to separate from the pole piece bottom die to obtain a hot melt adhesive ring-attached lithium ion battery pole piece;

(f) the movable platform switching the pasting station and the material loading station; and

(g) repeating Step (a), (b), (d) through (f).

### BRIEF DESCRIPTION OF THE DRAWINGS

The present invention will become more readily apparent to those ordinarily skilled in the art after reviewing the following detailed description and accompanying drawings, in which:

FIG. 1 is a stereogram of an adhesive pasting machine using an adhesive pasting apparatus according to an embodiment of the present invention;

FIG. 2 is a left view of the adhesive pasting machine using the adhesive pasting apparatus according to an embodiment of the present invention;

FIG. 3 is a stereogram of a pole piece bottom die according to an embodiment of the present invention;

FIG. 4 is a stereogram of a pasting die-head according to an embodiment of the present invention;

FIG. 5 is a front view of a closed and raised pasting surface with its inner and outer contour being square according to an embodiment of the present invention;

FIG. 6 is a front view of the closed and raised pasting surface with its inner and outer contour being rectangular according to an embodiment of the present invention;

FIG. 7 is a front view of the closed raised pasting surface with its inner and outer contour being circular according to an embodiment of the present invention;

FIG. 8 is a front view of the closed and raised pasting surface with its inner and outer contour being elliptical according to an embodiment of the present invention;

FIG. 9 is a front view of the closed raised pasting surface with its inner and outer contour being pentagonal according to an embodiment of the present invention;

FIG. 10 is a front view of the closed and raised pasting surface with its inner and outer contour being D-shaped according to an embodiment of the present invention;

FIG. 11 is a front view of the closed and raised pasting surface with its inner and outer contour being star-shaped according to an embodiment of the present invention;

FIG. 12 is a front view of the closed and raised pasting surface with its inner and outter contour being heart-shaped according to an embodiment of the present invention;

FIG. 13 is a structure diagram of the adhesive pasting apparatus during pasting according to an embodiment of the present invention;

FIG. 14 is a front view of the pasting die-head with the closed and raised pasting surface being a curved surface according to an embodiment of the present invention;

FIG. 15 is a stereogram of the pasting die-head with the closed and raised pasting surface being a curved surface according to an embodiment of the present invention;

FIG. 16 is a stereogram of the pole piece bottom die with the closed and raised pasting surface being a curved surface according to an embodiment of the present invention;

FIG. 17 is a stereogram of the pole piece bottom die with the closed and raised pasting surface being a curved surface according to another embodiment of the present invention;

FIG. 18 is a front view of the pasting die-head with a limit groove according to an embodiment of the present invention;

FIG. 19 is a stereogram of the pasting die-head with a limit groove according to an embodiment of the present invention;

FIG. 20 is a stereogram of the pole piece bottom die with a limit groove according to an embodiment of the present invention;

FIG. 21 is a stereogram of the pole piece bottom die with a limit groove according to another embodiment of the present invention;

FIG. 22 is a stereogram of a movable platform with a rotary bottom die according to an embodiment of the present invention; and

FIG. 23 is a stereogram of the movable platform with a rotary bottom die according to another embodiment of the present invention.

### DETAILED DESCRIPTION OF PREFERRED EMBODIMENTS

“Adhesive pasting” of the present invention refers to the operation that a hot melt adhesive ring has its exterior surface melted by heating upon contact with a lithium ion battery pole piece so that the hot melt adhesive ring would adhere to the lithium ion battery pole piece.

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

### The First Embodiment

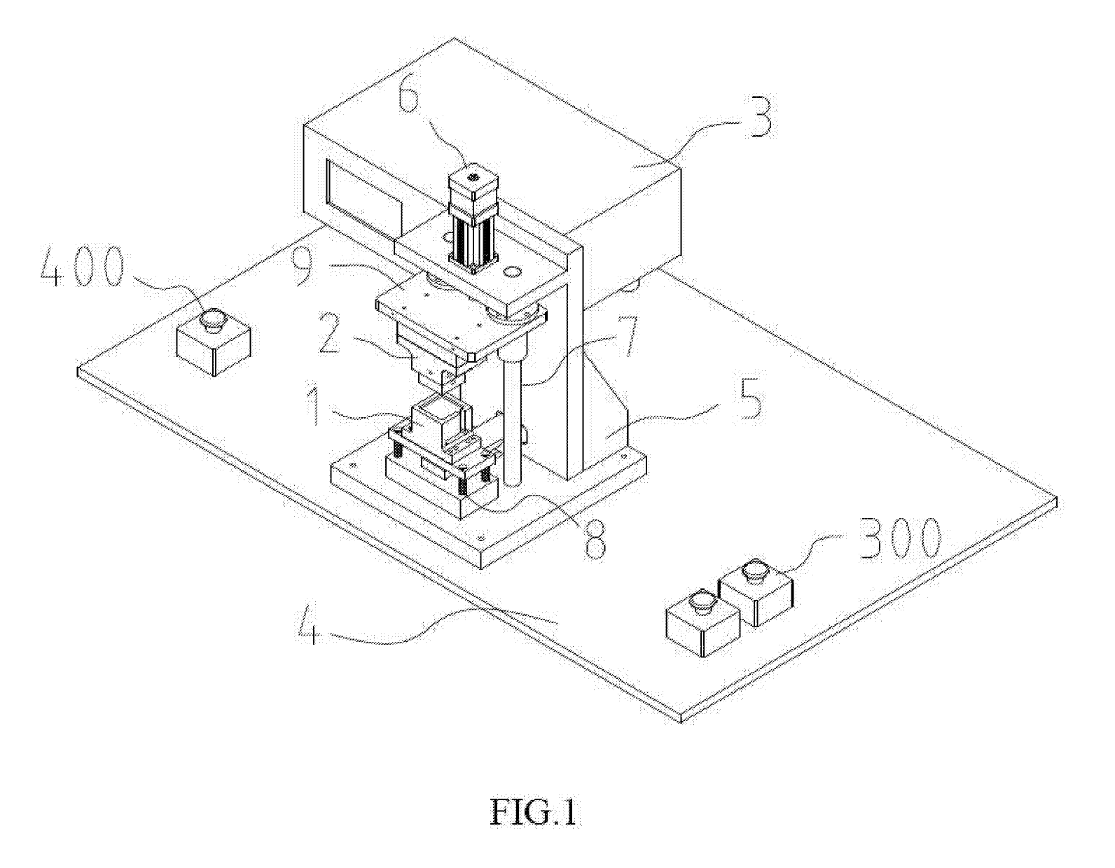

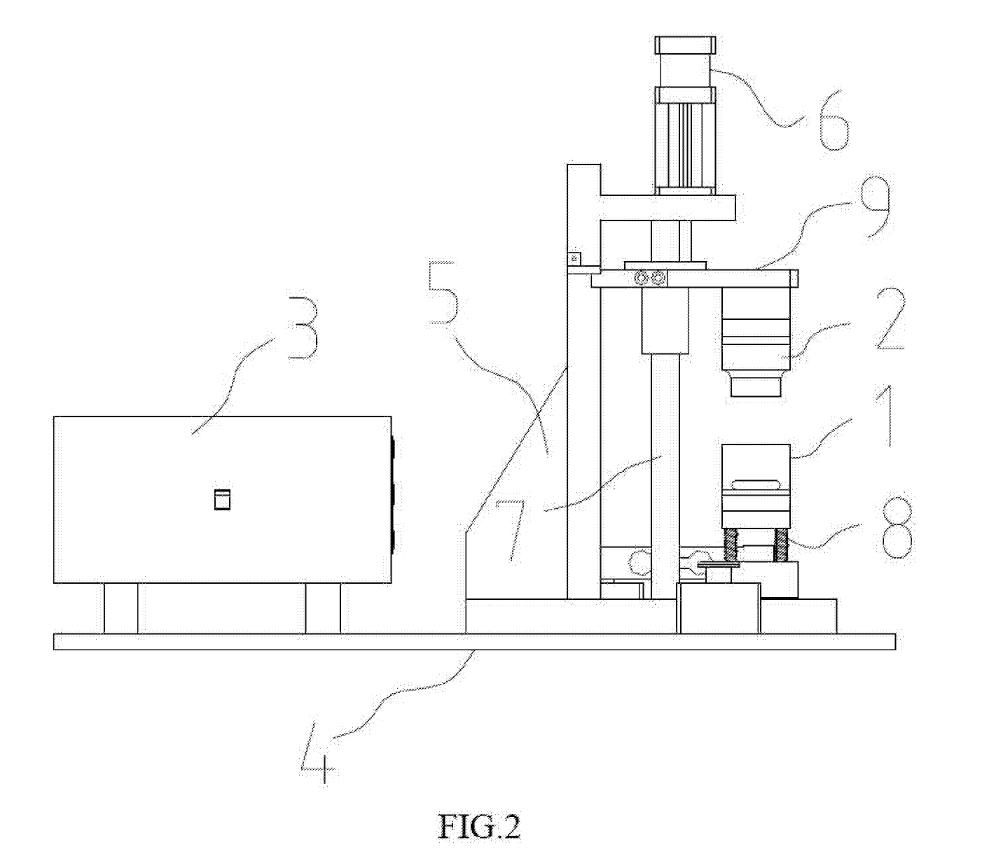

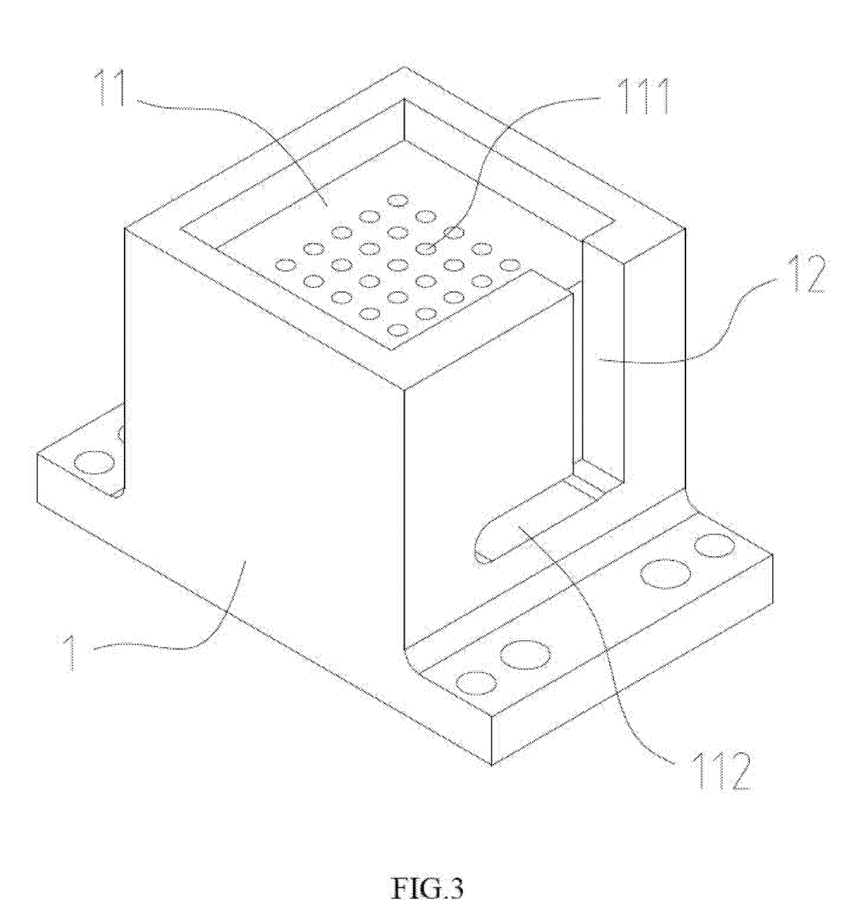

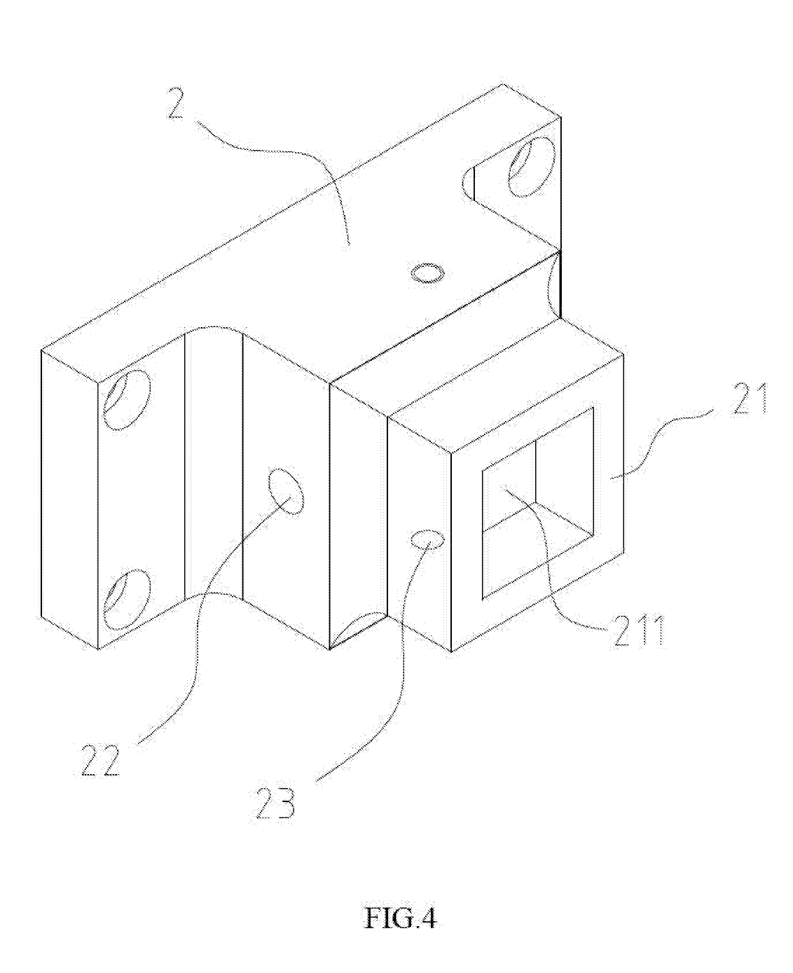

Referring to FIG. 1, FIG. 2 and FIG. 4. An adhesive pasting apparatus of the present embodiment includes a pole piece bottom die 1, a pasting die-head 2 and a controller 3. Referring to FIG. 3, the pole piece bottom die 1 has a pole piece cavity 11 to hold and position a pole piece, and the lower part of the pasting die-head 2 matches with the pole piece cavity 11 so that a lower end of the pasting die-head 2 is embedded into the pole piece cavity 11. The surface of the lower end of the pasting die-head 2 has a closed and raised pasting surface 21. The pasting die-head 2 has a heating element (not shown in figures) electrically connected to the controller 3.

Referring to FIG. 4. A temperature control element (not shown in figures) is disposed on the pasting die-head 2 and electrically connected to the controller 3, which detects the temperature of the pasting die-head 2. The pasting die-head 2 has a mounting hole 22 for the heating element and mounting hole 23 for the temperature control element. It would be faster for heat conduction when the heating element is built into the pasting die-head 2; therefore, it would be more accurate for detecting the temperature of the pasting die-head 2 when the temperature control element is built into the pasting die-head 2. Certainly one or more heating elements and temperature control elements may be disposed according to the requirements of usage to increase the heating rate and detection accuracy. Heating temperature of the heating elements ranges from 40° C. to 400° C.; however, the optimum heating temperature may be chosen by the user according to the material of pole piece. With the controller 3 controlling and the pasting die-head 2 detecting the temperature of the pasting die-head 2, the controller 3 adjusts and controls the temperature of the pasting die-head according to feedback information provided by the temperature control element(s) to achieve the required temperature for pasting.

The closed and raised pasting surface 21 is formed around an outer edge of the lower end of the pasting die-head 2, so that a groove 211 is formed at an interior of the lower end of the pasting die-head 2. Heat is concentrated at the hot melt adhesive ring and is spaced away from the paste composition in the middle part of the pole piece, thus preventing damage to the paste composition by heat and detrimental effects caused by unequal thickness between the paste composition of the pole piece and the hot melt adhesive ring.

Referring to FIG. 3 and FIG. 4. The closed and raised pasting surface 21 and a bottom surface of the pole piece cavity 11 are planes, which are suitable for a planar hot melted adhesive ring for the lithium ion battery pole piece.

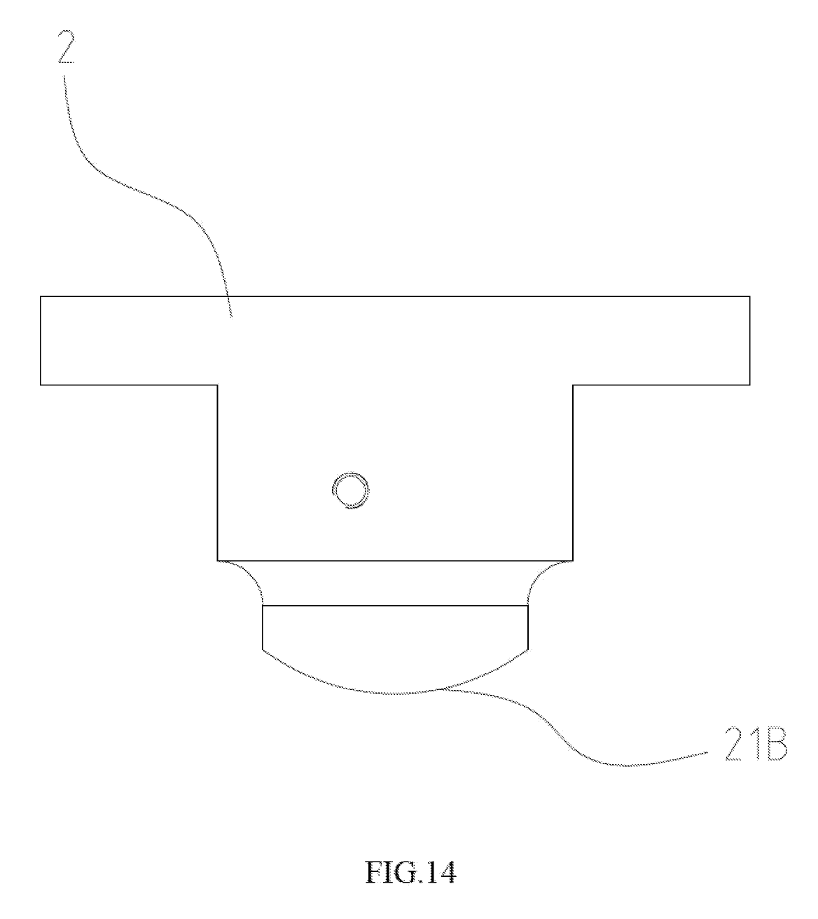

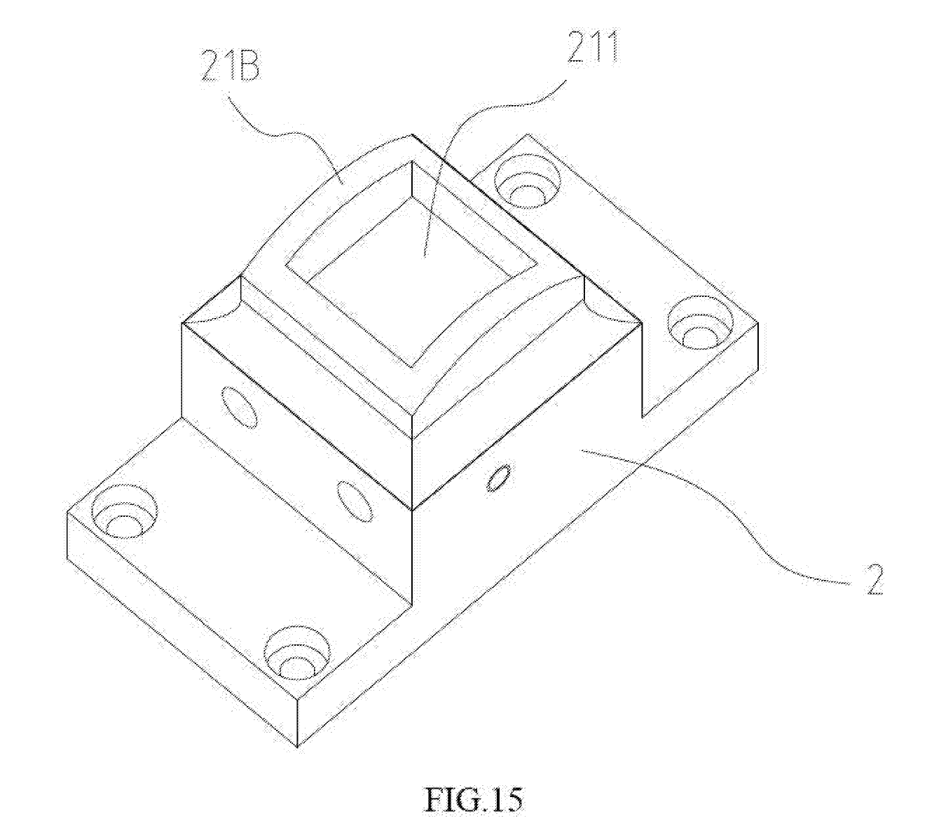

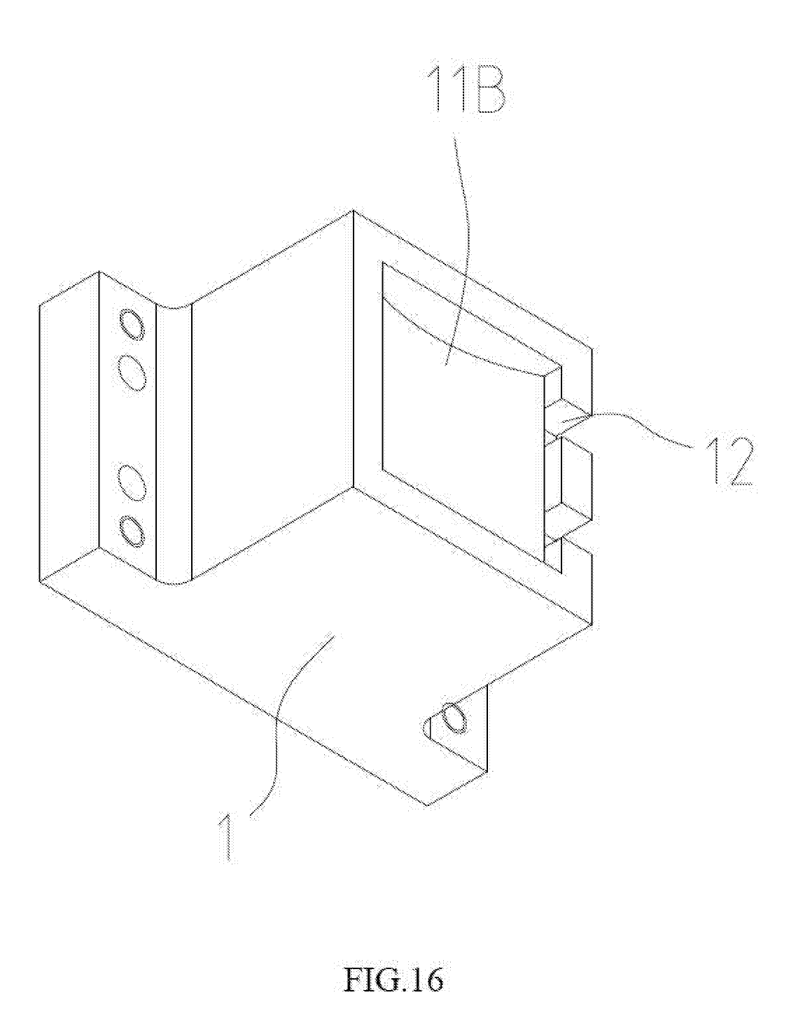

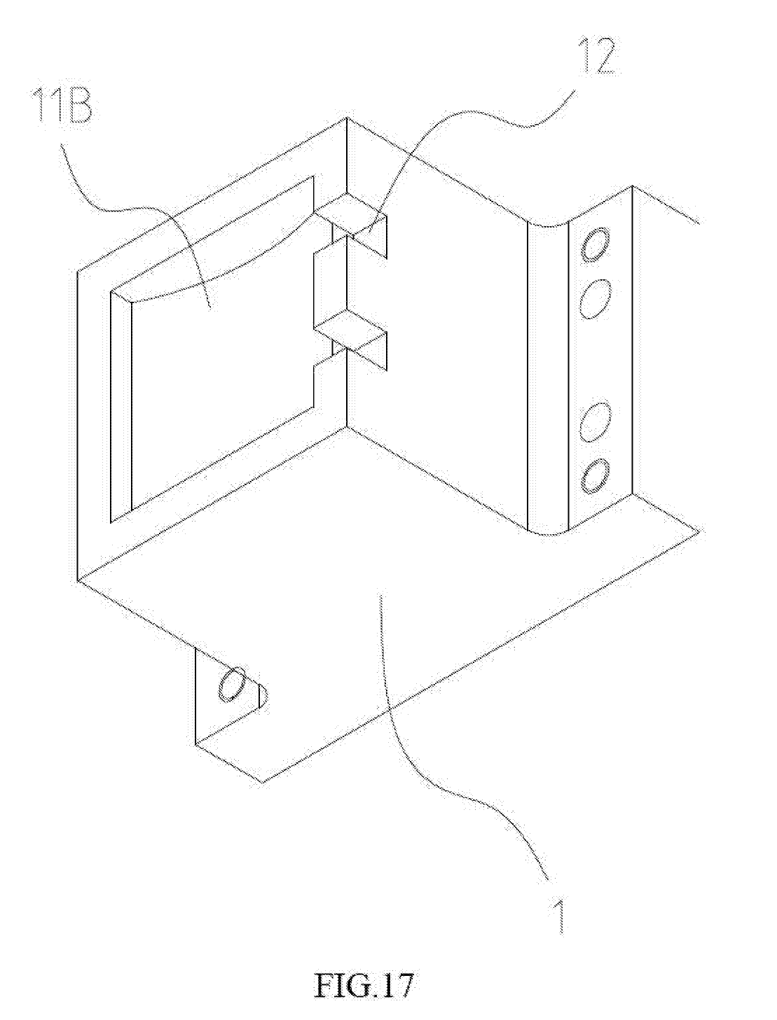

Referring to FIG. 14 to FIG. 17. In another embodiment of the pasting die-head 2 and the pole piece bottom die, the closed and raised pasting surface 21B and the bottom surface 11B of the pole piece cavity are complementary curved surfaces, which are suitable for a curved-shaped hot melted adhesive ring for the lithium ion battery pole piece.

Referring to FIG. 3. A lateral area of the pole piece cavity 11 is disposed of a plurality of pole piece tab retaining slots 12, which is used for retaining and positioning pole piece tabs. To place a pole piece, the pole piece is positioned by the pole piece tab retaining slots 12 firstly, and accurately positioned by fine adjustment afterwards. However, for pole pieces without pole piece tabs, it would not be necessary to dispose the pole piece tab retaining slots 12.

A plurality of air vents 111 are formed at certain intervals in the middle of the bottom surface of the pole piece cavity 11. An air cavity 112 is disposed on the lateral area of the pole piece bottom die 1 and interconnected with the bottom end of the air vents 111 to form a heat dissipation channel, which may increase the rate of heat dissipation during the pasting process. Heat dissipation may be further enhanced by aerating cooling gas into the air cavity 112, or by designing the air cavity 112 into a cool air sleeve and aerating cooling liquids into the air cavity 112, thus avoiding excessive heat accumulating at the bottom surface of the pole piece cavity 11, which would lead to melting of the bottom surface of the hot melt adhesive ring and adhesion to the bottom of the pole piece cavity 11.

Referring to FIG. 4. The closed and raised pasting surfaces may be equal or unequal in width. When the closed raised pasting surface has equal widths, the inner and outer contour thereof may be square, rectangular, rhombic, triangular, circular, elliptical, star-shaped, heart-shaped, pentagonal, D-shaped, or any other shapes. The inner and outer contours of the closed and raised pasting surface 21 shown in FIG. 4 are square.

When the closed and raised pasting surface has unequal widths, the inner contour and the outer contour thereof may be rectangular and square, square and rectangular, circular and square, elliptical and rectangular, elliptical and circular, circular and elliptical, or any other shapes, respectively.

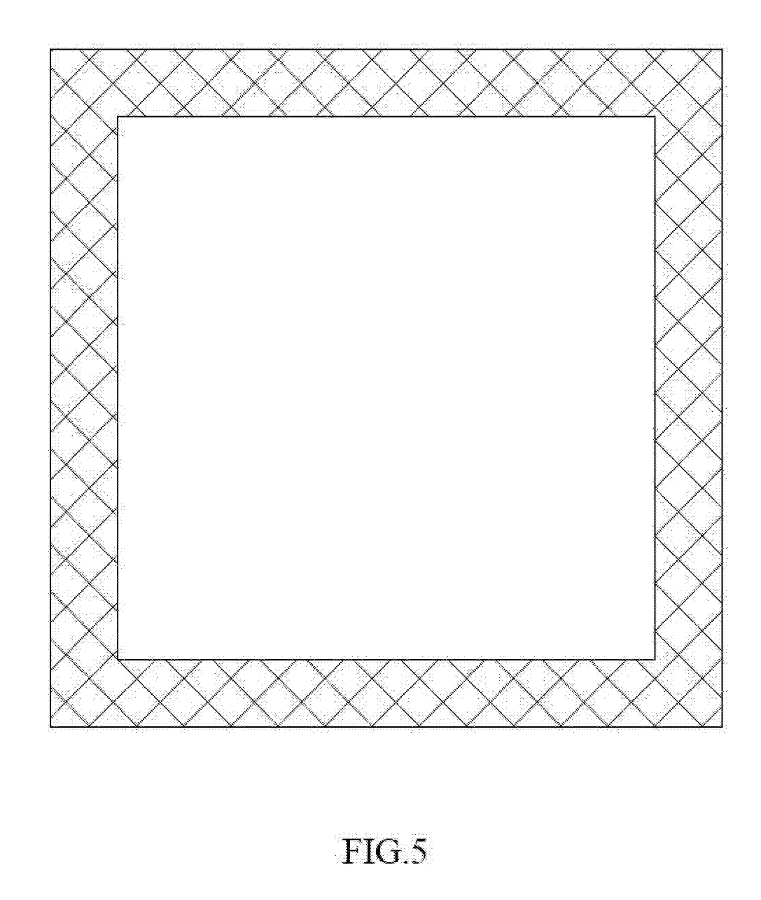

FIG. 5 to FIG. 12 shows the front views of different shapes of the closed and raised pasting surface.

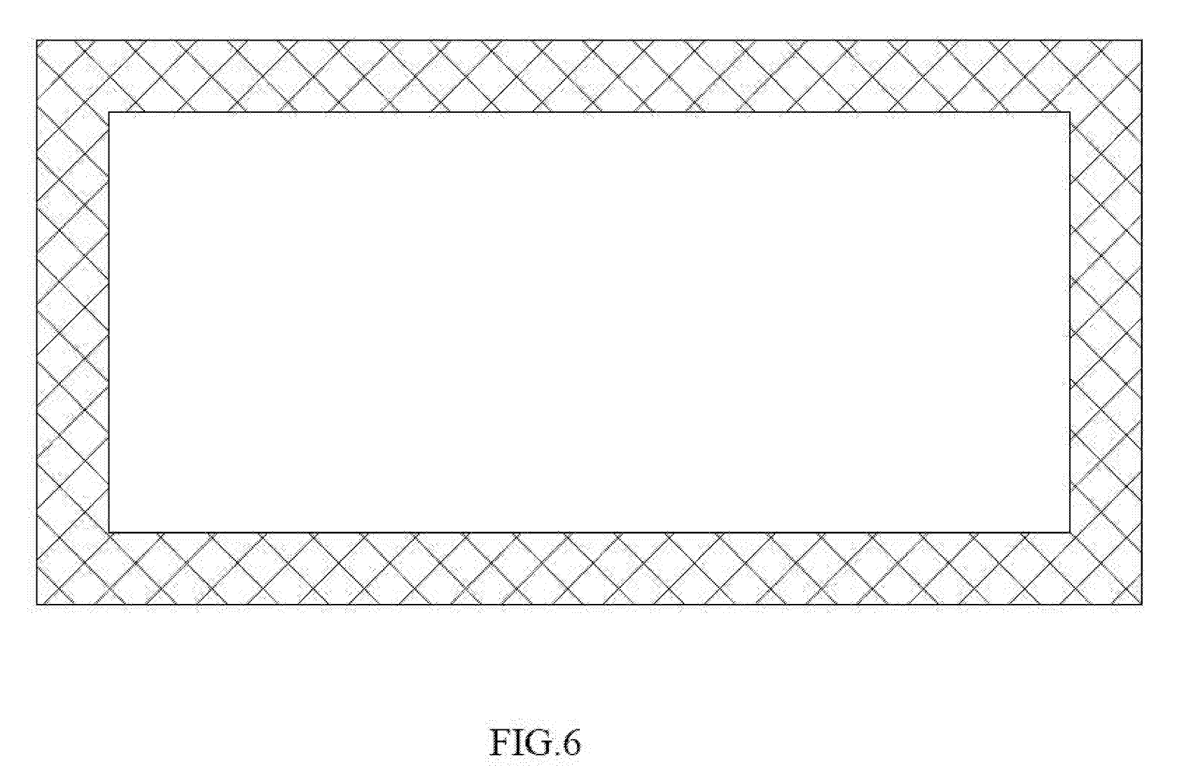

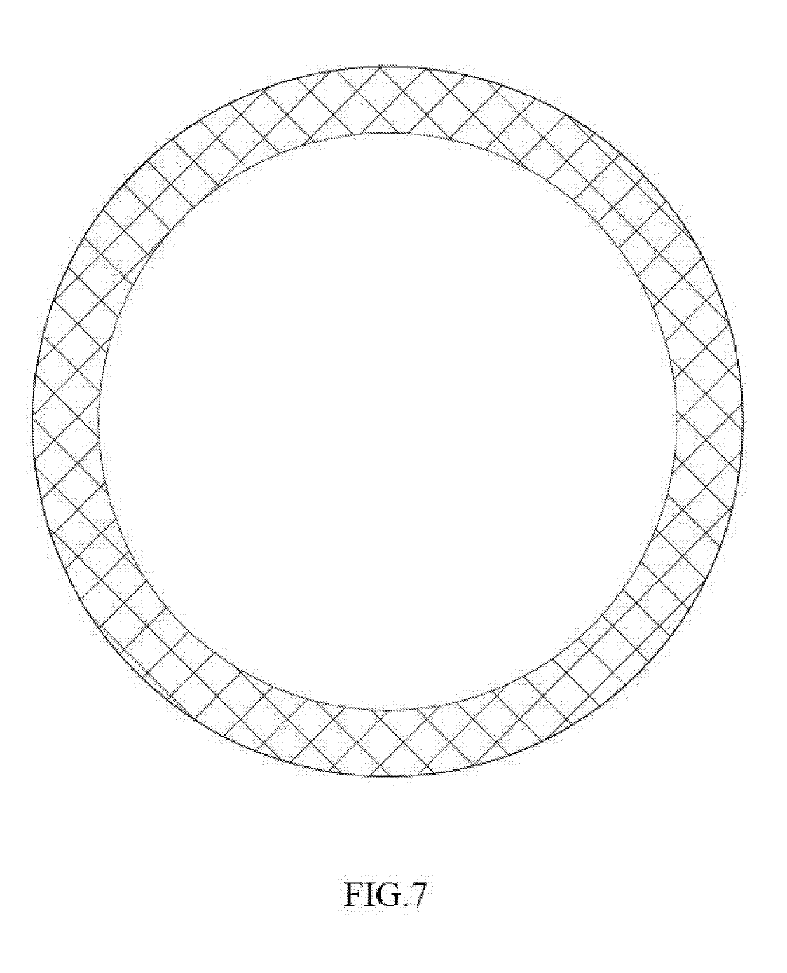

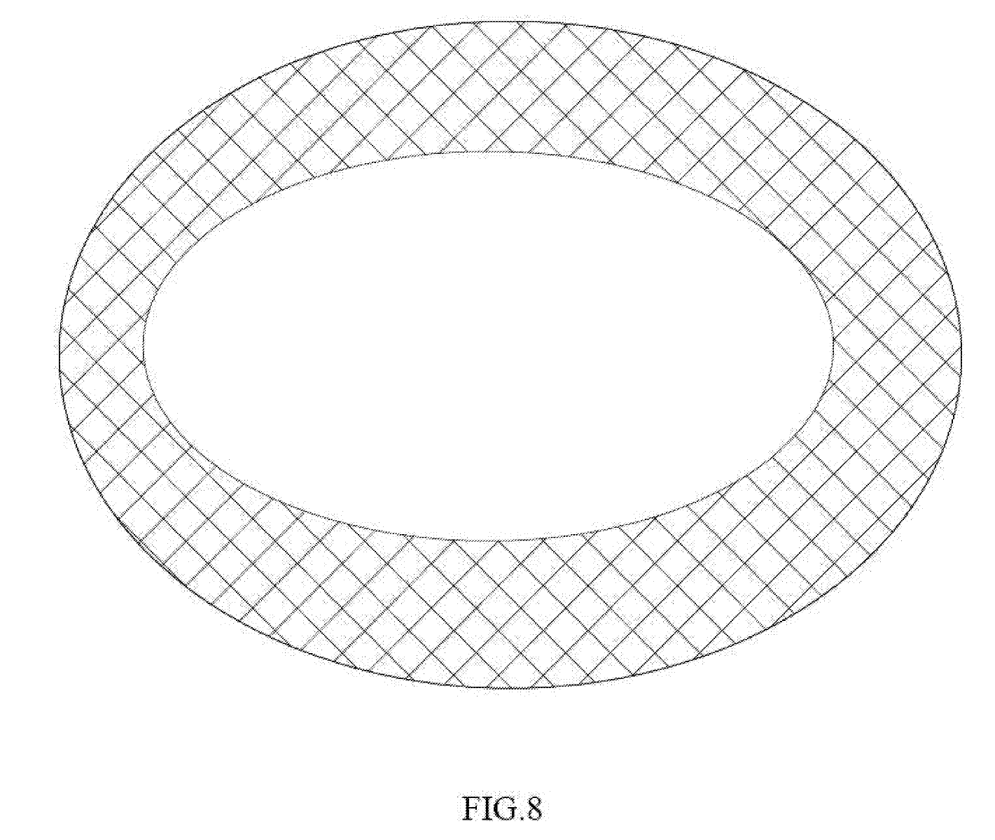

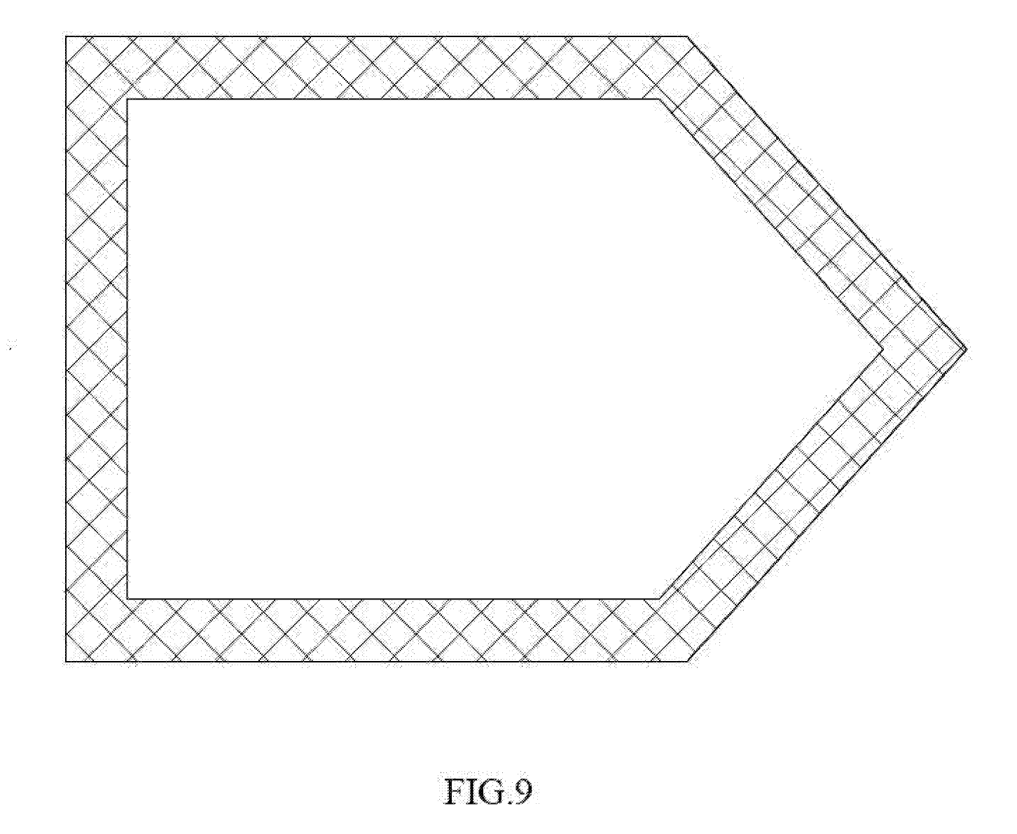

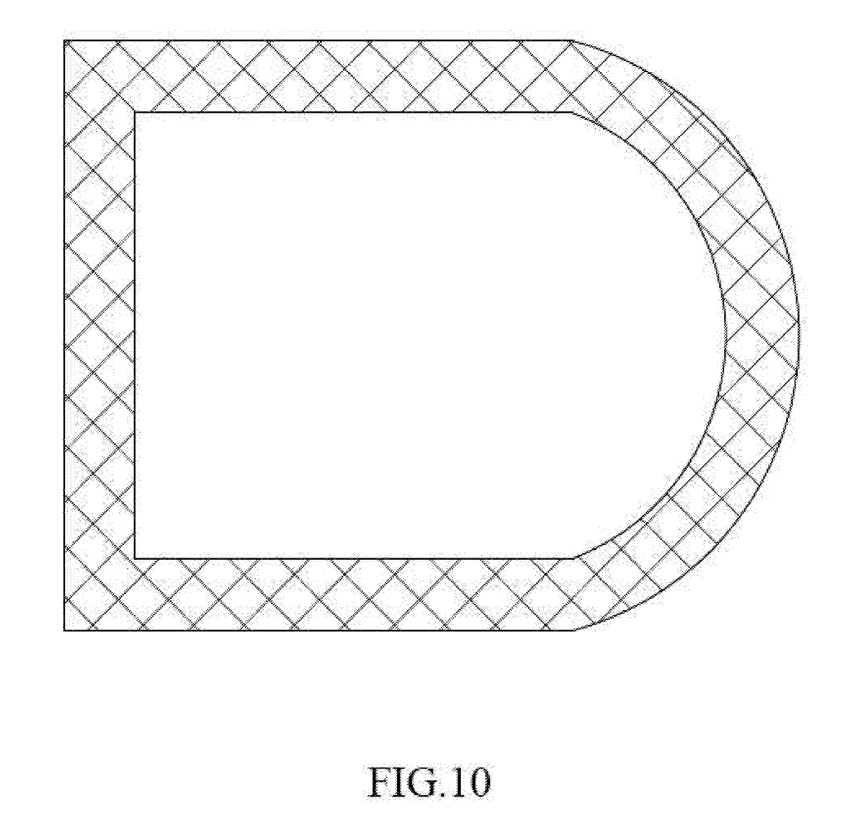

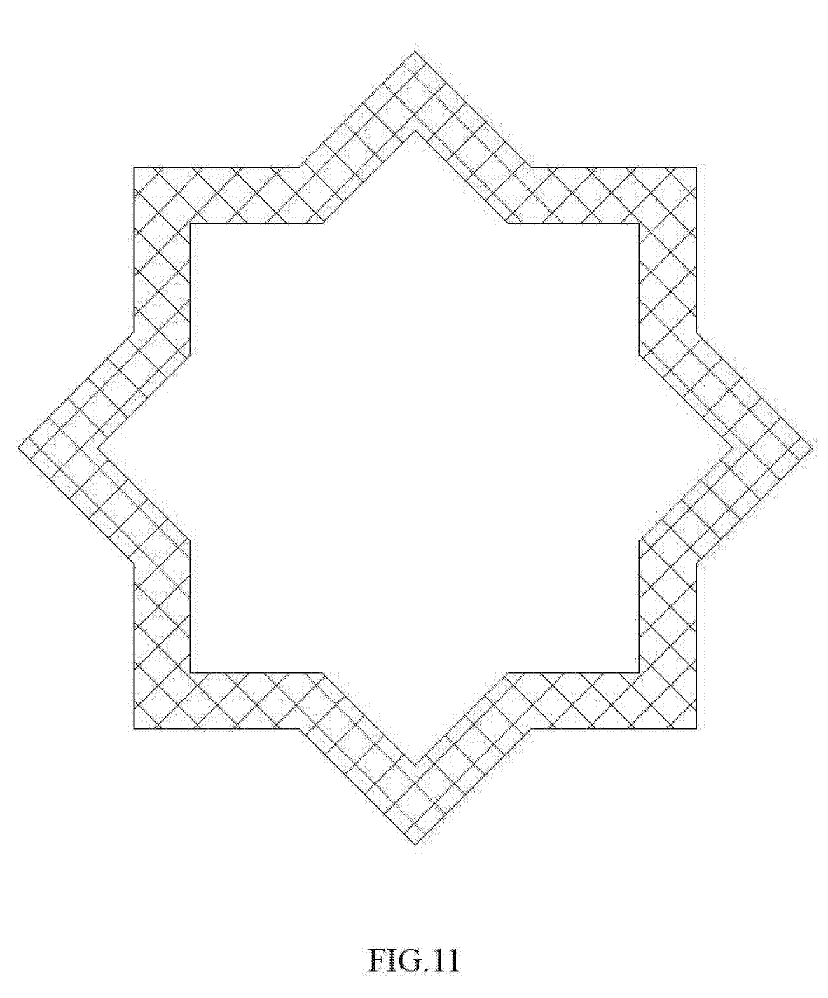

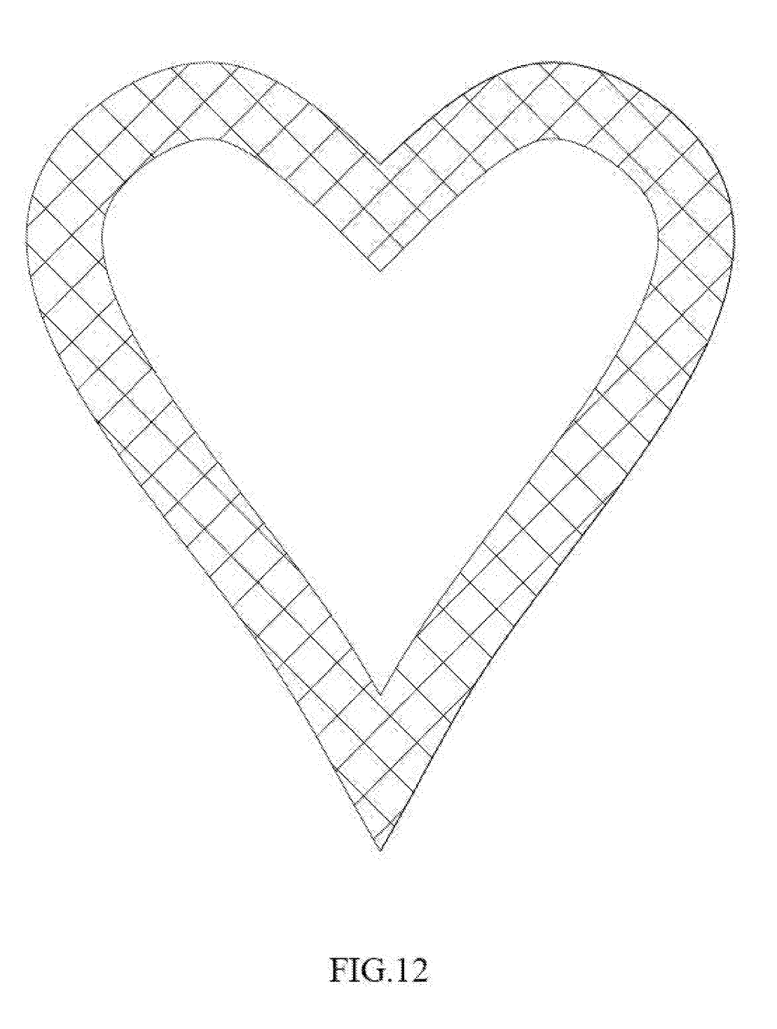

FIG. 5 is the closed and raised pasting surface with its inner and outer contour being square; FIG. 6 is the closed and raised pasting surface with its inner and outer contour being rectangle; FIG. 7 is the closed and raised pasting surface with its inner and outer contour being circular; FIG. 8 is the closed and raised pasting surface with its inner and outer contour being elliptical; FIG. 9 is the closed and raised pasting surface with its inner and outer contour being pentagonal; FIG. 10 is the closed and raised pasting surface with its inner and outer contour being D-shaped; FIG. 11 is the closed and raised pasting surface with its inner and outer contour being star-shaped; FIG. 12 is the closed and raised pasting surface with its inner and outer contour being heart-shaped. The geometric centre of the inner contour may not overlap with that of the outer contour; that is, the widths along the raised pasting surface may be inconsistent.

Operating principles of the embodiment are explained as the following:

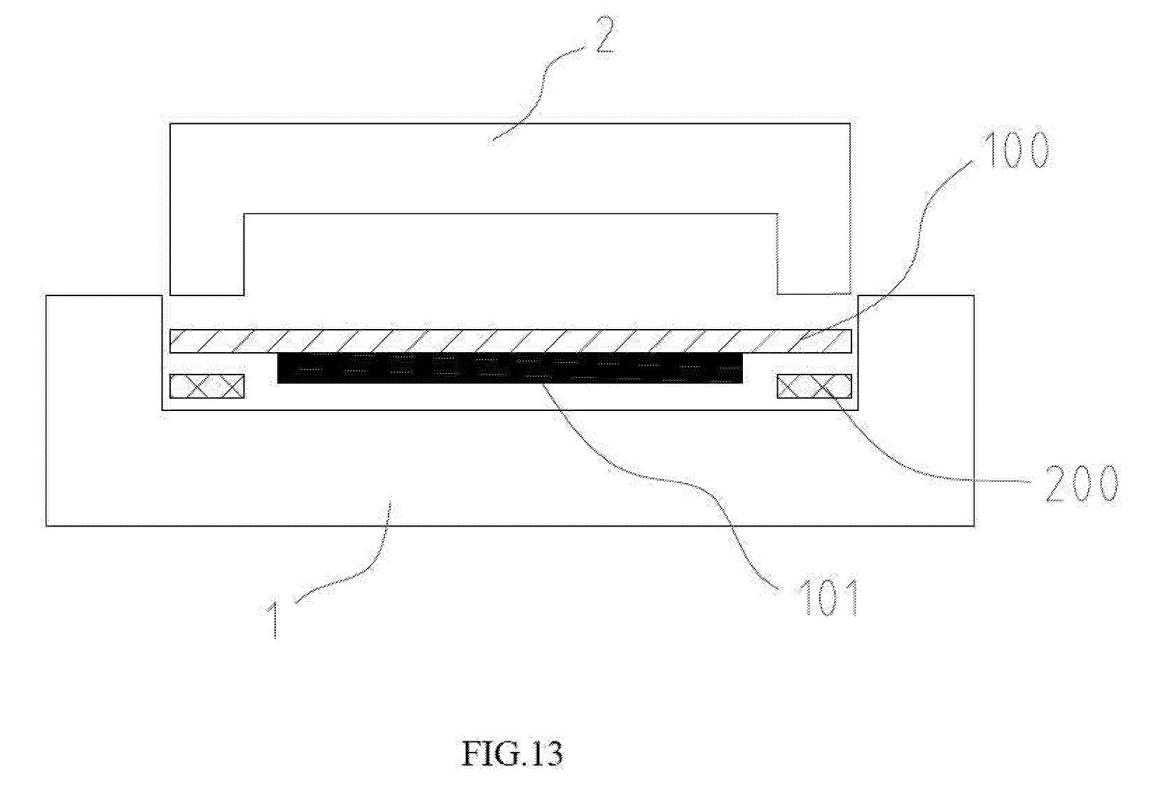

Referring to FIG. 3, FIG. 4 and FIG. 13. FIG. 13 is a schematic diagram of the pasting die-head 2 and the pole piece bottom die 1. In FIG. 13, 100 is a lithium ion battery pole piece, 101 is a paste composition on the lithium ion battery pole piece, and 200 is a hot melt adhesive ring.

In the adhesive pasting process, the hot melt adhesive ring 200 is placed in the pole piece cavity 11, a surface of the lithium ion battery pole piece 100 with the paste composition 101 is then disposed downward and positioned above the hot melt adhesive ring 200. The pole piece tabs are placed in the corresponding pole piece tab retaining slots 12, and the position of the pole piece is adjusted so that the area of the lithium ion battery pole piece 100 without any paste composition 101 corresponds to the upper part of the hot melt adhesive ring 200. Thereafter, the heating element is switched on to heat the pasting die-head 2 up to a pre-set temperature. The pasting die-head 2 is moved downward until the closed raised pasting surface 21 presses against the battery pole piece 100 on the pole piece bottom die 1, thus causing the exterior surface of the hot melt adhesive ring 200 to melt by the heated pasting die-head 2. Consequently, the hot melt adhesive ring 200 is adhered to the lithium ion battery pole piece 100. After the pasting die-head 2 is removed, a lithium ion battery pole piece with the hot melt adhesive ring 200 attached thereto is obtained.

### The Second Embodiment

The present embodiment provides an adhesive pasting machine using the adhesive pasting apparatus of the first embodiment. Referring to FIG. 1 and FIG. 2, which provides 3 design solutions as follows:

The first design solution: the adhesive pasting machine includes a rack and a driver 6. The rack includes a rack platform 4 and a pedestal 5. The pole piece bottom die 1 is disposed in a bottom part of the pedestal 5, and the pasting die-head 2 is disposed in an upper part of the pedestal 5 and driven by the driver 6. The controller 3 is disposed on the rack platform 4 and electrically connected to the driver 6. The pasting die-head 2 is connected to the driver 6 through a connecting plate 9, which has two linear guides symmetrically arranged to ensure stability of the pasting die-head 2. A buffered device 8 is provided between the bottom of the pole piece bottom die 1 and the pedestal 5; preferably, the buffered device is a spring. The rack platform 4 has a power switch 400 and a control switch 300 for controlling on-off switching of the adhesive pasting machine and the heating of the pasting die-head 2. The operations of the driver 6 may be controlled by programming input from the controller 3 or manually controlling the control switch 300. Also, the control switch 300 may be disposed under the rack and controlled by a foot pedal. An emergency stop switch may also be disposed to control the driver 6 to make an immediate shut-off.

Operating principles of the embodiment are explained as the following:

Referring to FIG. 3, FIG. 4 and FIG. 13. FIG. 13 is a schematic diagram of the pasting die-head 2 and the pole piece bottom die 1. In FIG. 13, 100 is a lithium ion battery pole piece, 101 is a paste composition on the lithium ion battery pole piece, and 200 is a hot melt adhesive ring.

In the adhesive pasting process, the hot melt adhesive ring 200 is placed in the pole piece cavity 11, a surface of the lithium ion battery pole piece 100 with the paste composition 101 is then disposed downward and positioned above the hot melt adhesive ring 200. The pole piece tabs are placed in the corresponding pole piece tab retaining slots 12, and the position of the pole piece is adjusted so that the area of the lithium ion battery pole piece 100 without any paste composition 101 corresponds to the upper part of the hot melt adhesive ring 200. Thereafter, the heating element is switched on to heat the pasting die-head 2 is up to a pre-set temperature. The pasting die-head 2 is moved downward until the closed and raised pasting surface 21 presses against the lithium ion battery pole piece 100, thus causing the exterior surface of the hot melt adhesive ring 200 to melt by the heated pasting die-head 2. Consequently, the hot melt adhesive ring is adhered to the lithium ion battery pole piece. After the heated pasting die-head 2 is removed, a lithium ion battery pole piece with the hot melt adhesive ring 200 attached thereto is obtained.

The second design solution: the adhesive pasting machine includes a rack and a driver. The rack includes a rack platform and a pedestal. The pasting die-head is disposed in the upper part of the pedestal, and the pole piece bottom die is disposed in the bottom part of the pedestal and driven by the driver. The controller is disposed on the rack platform and electrically connected to the driver. The difference of this design solution from the first design solution lies in that the driver drives the pole piece bottom die to move upward, instead of the pasting die-head to move downward; other technical features remains the same with the first design solution.

The third design solution: the adhesive pasting machine includes a rack and a driver. The rack includes a rack platform and a pedestal. The pasting die-head is disposed in the upper part of the pedestal, and the pole piece bottom die is disposed in the bottom part of the pedestal. Two drivers are disposed and drive the pole piece bottom die and the pasting die-head respectively. The controller is disposed on the rack platform and electrically connected to the driver. The difference of this design solution from the first design solution lies in that the driver drives both the pole piece bottom die and the pasting die-head to move simultaneously toward each other; other technical features remains the same with the first design solution.

The driver 6 may be a gas cylinder, a screw motor, a servo motor or a stepper motor. When being a gas cylinder, the driver 6 is connected to the controller 3 by an air channel; alternatively, when being a screw motor, a servo motor or a stepper motor, the driver 6 is connected to the controller 3 by electrical circuits.

As an improved technical solution, the adhesive pasting machine may further include two or more pole piece bottom dies 1 and two or more pasting die-heads 2. The two or more pole piece bottom dies 1 and the two or more pasting die-heads 2 are disposed correspondingly and are driven by different drivers, so that a plurality of pasting operations may be performed; that is, materials loading, adhesive pasting, and unloading the pole piece with an attached hot melt adhesive ring may be performed at the same time.

In another improved technical solution, the adhesive pasting machine may further include two or more pole piece bottom dies 1 disposed on a movable platform (not shown in figures) at the bottom of the pedestal 5. The movable platform is electrically connected to the controller 3 and performs translational movements or rotational movements under the instruction of the controller 3, so that the pole piece bottom dies 1 may be moved around between a pasting station and a material loading station of the adhesive pasting machine, thus enabling circulatory operations among various stations and greatly improving the processing efficiency.

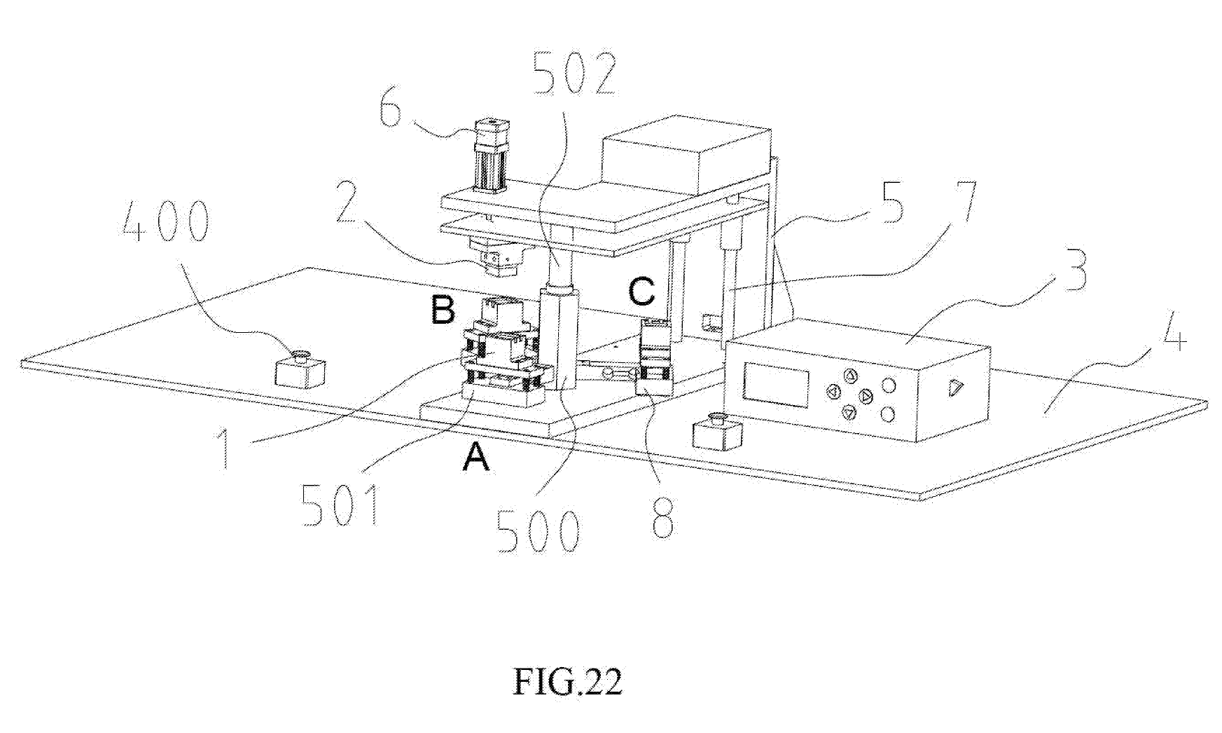

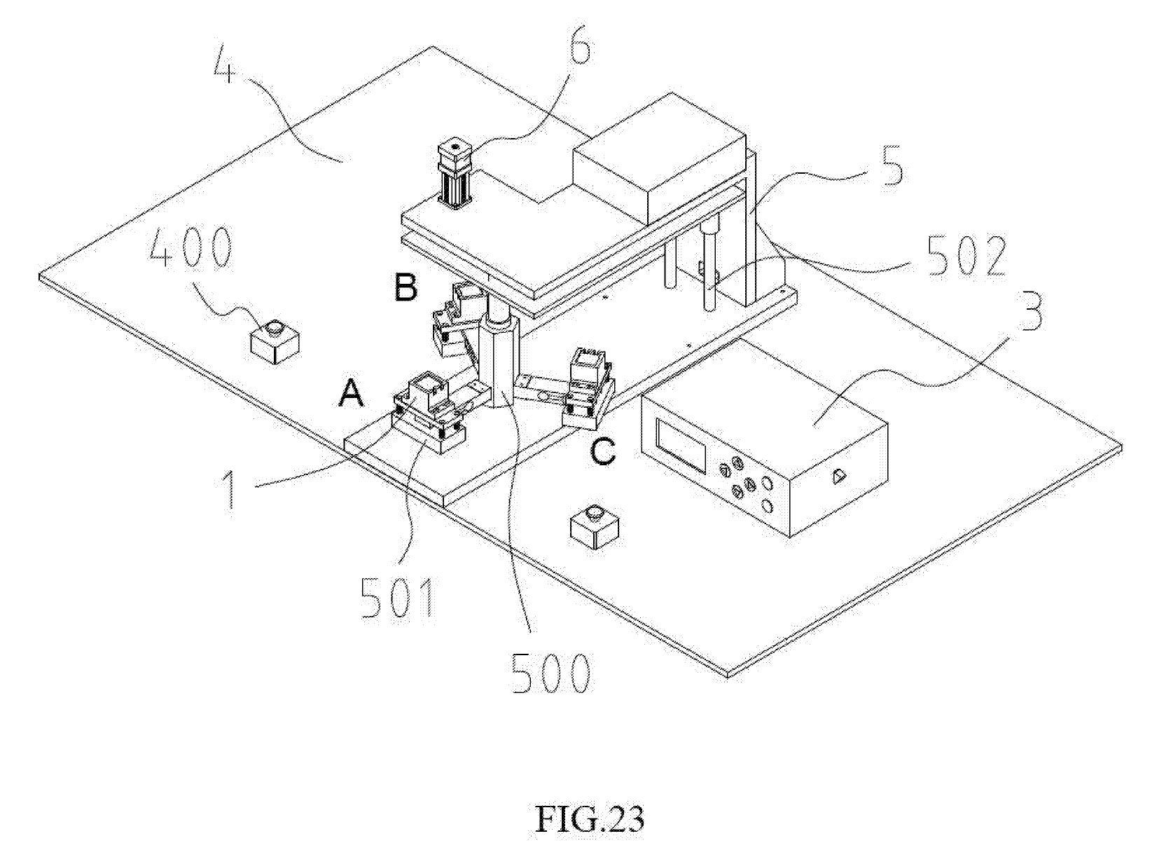

Referring to FIG. 22 and FIG. 23. In a preferred embodiment of the present invention, the movable platform enables rotational movements of the pole piece bottom dies 1. In the present embodiment, three equally distributed stations, A, B and C, are disposed annularly, with each bearing a pole piece bottom die 1. Each of the pole piece bottom dies 1 connects to the movable platform 500 through a connecting base 501, and the three pole piece bottom dies 1 are disposed equally around the movable platform 500. Station A is a material loading station disposed on the front side so as to facilitate material loading; Station B is an adhesive pasting station disposed on the left side; and station C is a material cooling and ejecting station disposed on the right side. When operating, each of the pole piece bottom dies 1 rotates clockwise around the movable platform and is positioned above stations A, B and C. The movable platform 500 is driven by a rotational drive mechanism that connects to the pedestal 5 through a connecting shaft 502 and rotates around the connecting shaft 502.

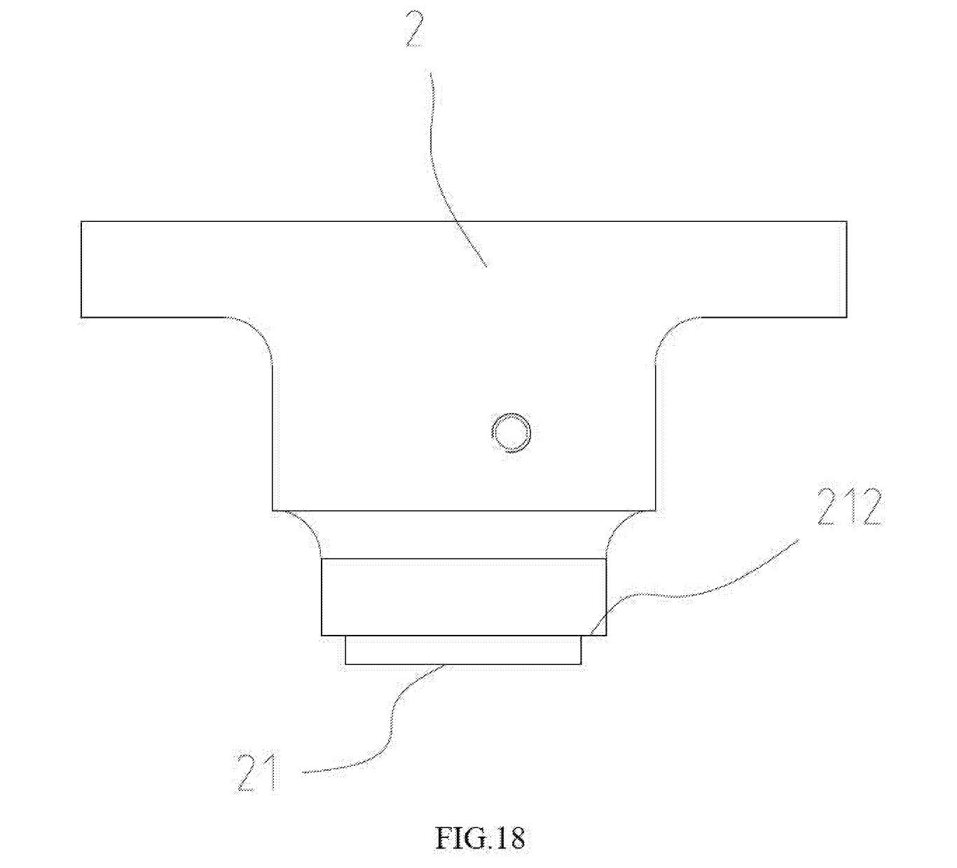

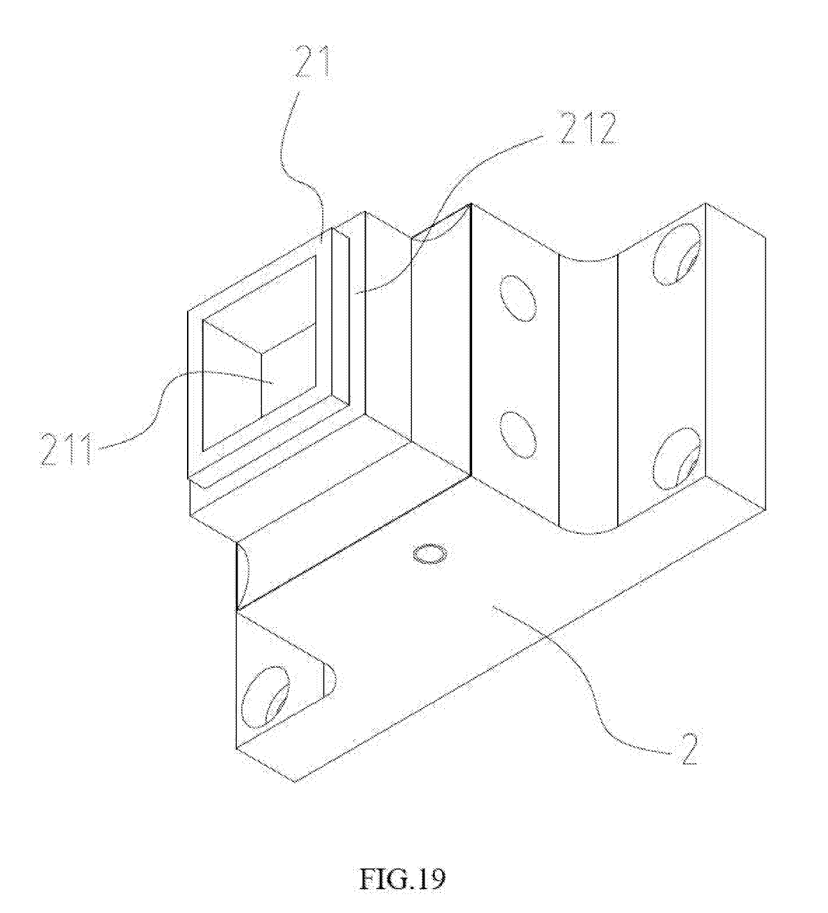

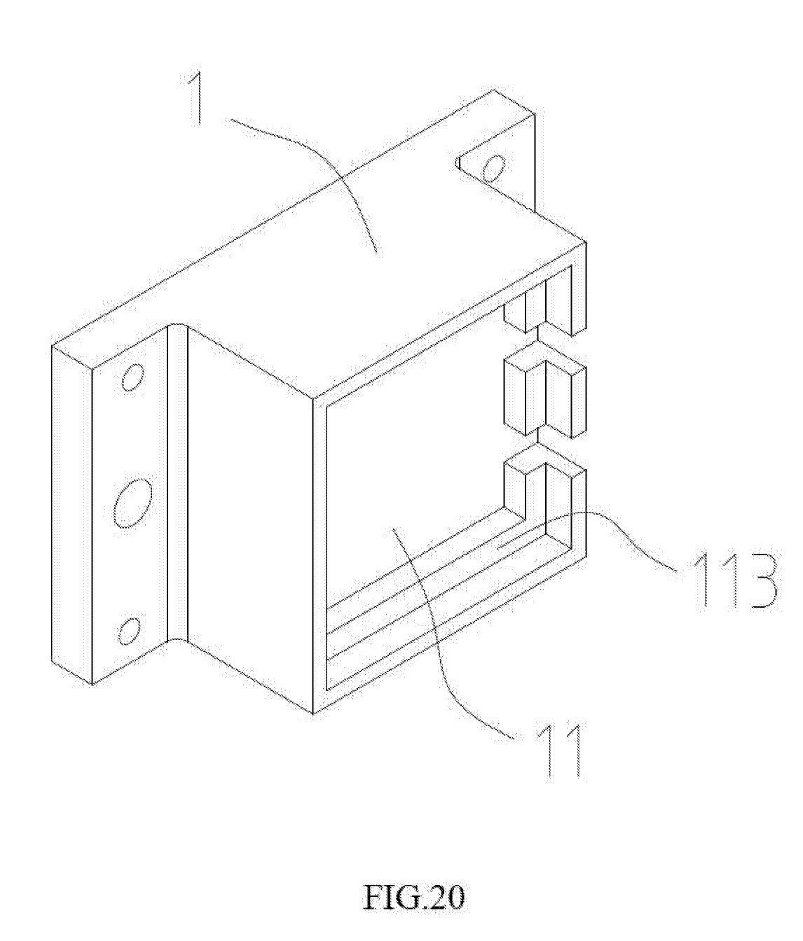

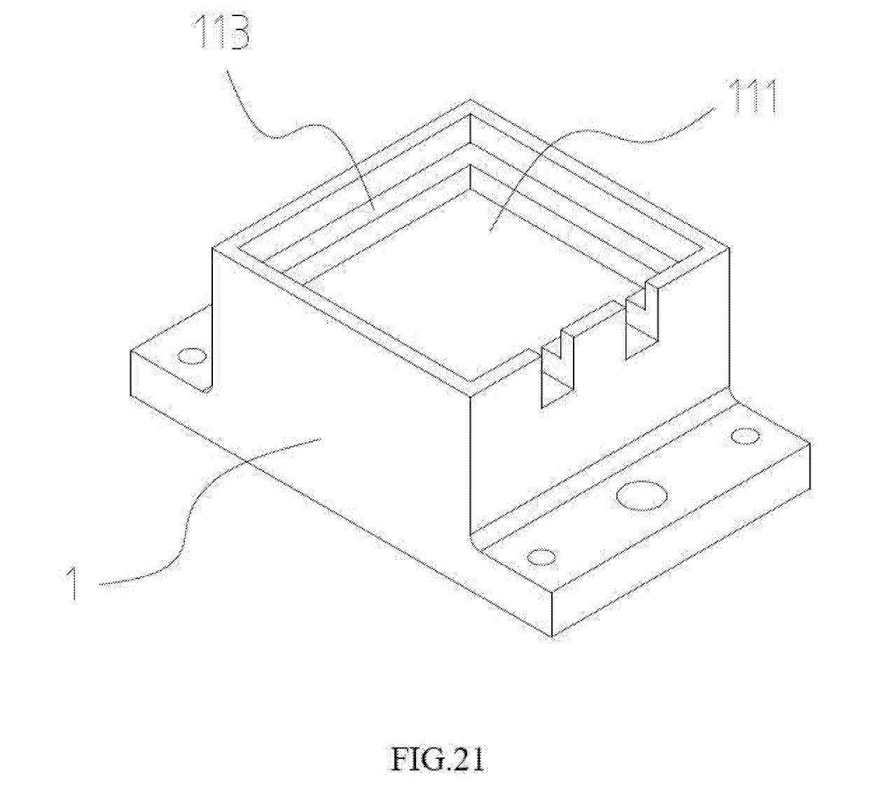

During the pasting process, pressure limiting control and thickness limiting control may be adopted to avoid breakage of the lithium ion battery pole piece 100 under excessive pressure. In pressure limiting control, a pressure sensor is disposed under the pasting die-head 2 or the pole piece bottom die 1. The pressure sensor is electrically connected to the controller 3 for controlling the pressure and time of the adhesive pasting according to feedbacks provided by the pressure sensors, thus ensuring the quality of adhesive pasting. Referring to FIG. 18 to FIG. 21. In thickness limit control, a limit groove 113 is formed on the pole piece bottom die 1 and is a stepped structure with an expanded upper end. Correspondingly, a stop step structure 212, matching the limit groove 113 is disposed around the outer edge of the closed and raised pasting surface 21. When the stop step structure 212 reaches the limit groove 113, the pasting die-head 2 stops moving to prevent the hot melt adhesive ring 200 and the lithium ion battery pole piece 100 from rushing damage during the pasting process. In a preferred embodiment, the pressure limiting control and the thickness limiting control are adopted simultaneously.

Moreover, the controller 3 may record the number of lithium ion battery pole pieces and display the number on a display screen according to the feedback information obtained from the movement state of the driver 6.

### The Third Embodiment

The present embodiment is an adhesive pasting method to be used by the adhesive pasting machine of the second embodiment.

Referring to FIG. 1, FIG. 3, FIG. 4 and FIG. 13. The first adhesive pasting method includes the steps of:

(a) putting the hot melt adhesive ring 200 in the pole piece cavity 11;

(b) disposing a surface of the lithium ion battery pole piece 100 with the paste composition 101 downward so that the paste composition 101 of the lithium ion battery pole piece 100 corresponds to the hollow part of the hot melt adhesive ring 200 and that a lateral side of the surface of the lithium ion battery pole piece 100 without any paste composition corresponds to the upper part of the hot melt adhesive ring 200;

(c) switching on the heating element to heat the pasting die-head 2 to a pre-set temperature;

(d) switching on the driver 6 to drive the pasting die-head 2 to move downward, the pole piece bottom die 1 to move upward, or the pasting die-head 2 and the pole piece bottom die 1 to move toward each other simultaneously, until the closed and raised pasting surface 21 presses against the lithium ion battery pole piece 100, thus causing the heated pasting die-head 2 to melt the exterior surface of the hot melt adhesive ring 200 and allowing the hot melt adhesive ring 200 to adhere to the lithium ion battery pole piece 100; and

(e) the driver 6 driving the pasting die-head 2 to separate from the pole piece bottom die 1 to obtain a lithium ion battery pole piece with the hot melt adhesive ring 200 attached thereto.

The aforementioned Step (c) may be performed before or between Step (a) and Step (b), which would result in the same effect.

Referring to FIG. 1, FIG. 3, FIG. 4 and FIG. 13. The second adhesive pasting method includes the steps of:

(a) putting the hot melt adhesive ring 200 in the pole piece cavity 11;

(b) disposing a surface of the lithium ion battery pole piece 100 with the paste composition 101 downward so that the paste composition 101 of the lithium ion battery pole piece 100 corresponds to the hollow part of the hot melt adhesive ring 200 and that a lateral side of the surface of the lithium ion battery pole piece 100 without any paste composition corresponds to the upper part of the hot melt adhesive ring 200;

(c) switching on the heating element to heat the pasting die-head 2 to a pre-set temperature;

(d) switching on the driver 6 to drive the pasting die-head 2 to move downward, the pole piece bottom die 1 to move upward, or the pasting die-head 2 and the pole piece bottom die 1 to move toward each other simultaneously, until the raised pasting surface 21 presses against the lithium ion battery pole piece 100, thus causing the heated pasting die-head 2 to melt the exterior surface of the hot melt adhesive ring 200 and allowing the hot melt adhesive ring 200 to adhere to the lithium ion battery pole piece 100;

(e) the driver 6 driving the pasting die-head 2 to separate from the pole piece bottom die 1 to obtain a lithium ion battery pole piece with the hot melt adhesive ring 200 attached thereto;

(f) the movable platform switching between the pasting station and the material loading station; and

(g) repeating Step (a), (b), (d) through (f).

The aforementioned Step (c) may be performed before or between Step (a) and Step (b), which would result in the same effect.

The adhesive pasting method according to the embodiments of the present invention allows hot melt adhesive rings of different shapes to adhere to lithium ion battery pole pieces with corresponding shapes, thus obtaining lithium ion battery pole pieces with hot melt adhesive rings attached thereto.

FIG. 5 to FIG. 12 exemplarily illustrate some shapes of the closed and raised pasting surface; various other shapes may be designed. Correspondingly, the pole piece bottom die should be designed to match the shapes of the closed and raised pasting surface, and the shapes of the hot melt adhesive rings and the pole pieces should be complementary.

According to the disclosure and teaching of above-mentioned specification, those skilled in the art of the present invention can still make changes and modifications to above-mentioned embodiment, therefore, the scope of the present invention is not limited to the specific embodiments disclosed and described above, and all those modifications and changes to the present invention are within the scope of the present invention as defined in the appended claims. Besides, although some specific terminologies are used in the specification, it is merely as a clarifying example and shall not be constructed as limiting the scope of the present invention in any way.

What is claimed is:

1. An adhesive pasting method for lithium ion battery pole piece, an adhesive pasting machine using the adhesive pasting method comprising a pole piece bottom die; a pasting die-head; a controller; a rack; and a driver,
wherein the rack comprises a rack platform and a pedestal, the pole piece bottom die is disposed in a bottom part of the pedestal, the pasting die-head is disposed in an upper part of the pedestal and driven by the driver, the controller is disposed on the rack platform and electrically connected to the driver,
the pole piece bottom die has a pole piece cavity configured to hold and position a pole piece, a lower part of the pasting die-head matches with the pole piece cavity so that a lower end of the pasting die-head is embedded into the pole piece cavity, a surface of the lower end of the pasting die-head has a closed and raised pasting surface, and the pasting die-head comprises a heating element electrically connected to the controller, and
the adhesive pasting method comprising the steps of:
(a) putting a hot melt adhesive ring in the pole piece cavity;
(b) disposing a surface of a lithium ion battery pole piece with a paste composition downward so that the paste composition of the lithium ion battery pole piece corresponds to a hollow part of the hot melt adhesive ring and that a lateral side of the surface of the lithium ion battery pole piece without any paste composition corresponds to an upper part of the hot melt adhesive ring;
(c) switching on the heating element to heat the pasting die-head to a pre-set temperature;
(d) switching on the driver to drive the pasting die-head to move downward until the closed and raised pasting surface of the pasting die-head presses against the lithium ion battery pole piece, thus causing the heated pasting die-head to melt an exterior surface of the hot melt adhesive ring and allowing the hot melt adhesive ring to adhere to the lithium ion battery pole piece; and
(e) the driver driving the pasting die-head to separate from the pole piece bottom die to obtain a lithium ion battery pole piece with the hot melt adhesive ring attached thereto.

2. The adhesive pasting method for lithium ion battery pole piece according to claim 1, wherein the adhesive pasting machine further comprises two or more pole piece bottom dies and two or more pasting die-heads, and the two or more pole piece bottom dies and the two or more pasting die-heads are disposed correspondingly.

3. The adhesive pasting method for lithium ion battery pole piece according to claim 1, wherein Steps (d) and (e) are replaced by the steps of:
(d′) switching on the driver to drive the pole piece bottom die to move upward until the lithium ion battery pole piece presses against the closed and raised pasting surface of the pasting die-head, thus causing the heated pasting die-head to melt the exterior surface of the hot melt adhesive ring and allowing the hot melt adhesive ring to adhere to the lithium ion battery pole piece; and
(e′) the driver driving the pole piece bottom die to separate from the pasting die-head to obtain a lithium ion battery pole piece with the hot melt adhesive ring attached thereto.

4. The adhesive pasting method for lithium ion battery pole piece according to claim 3, wherein the adhesive pasting machine further comprises two or more pole piece bottom dies and two or more pasting die-heads, and the two or more pole piece bottom dies and the two or more pasting die-heads are disposed correspondingly.

5. The adhesive pasting method for lithium ion battery pole piece according to claim 1, wherein the adhesive pasting machine includes two drivers configured to drive the pole piece bottom die and the pasting die-head respectively, and Steps (d) and (e) are replaced by the steps of:
(d″) switching on the driver to simultaneously drive the pasting die-head and the pole piece bottom die to move toward each other until the lithium ion battery pole piece presses against the closed and raised pasting surface of the pasting die-head, thus causing the heated pasting die-head to melt the exterior surface of the hot melt adhesive ring and allowing the hot melt adhesive ring to adhere to the lithium ion battery pole piece; and
(e″) the driver driving the pasting die-head to separate from the pole piece bottom die to obtain a lithium ion battery pole piece with the hot melt adhesive ring attached thereto.

6. The adhesive pasting method for lithium ion battery pole piece according to claim 5, wherein the adhesive pasting machine further comprises two or more pole piece bottom dies and two or more pasting die-heads, and the two or more pole piece bottom dies and the two or more pasting die-heads are disposed correspondingly.

7. The adhesive pasting method for lithium ion battery pole piece according to claim 1, wherein the pasting die-head further comprises a plurality of heating elements electrically connected to the controller.

8. The adhesive pasting method for lithium ion battery pole piece according to claim 1, wherein the closed and raised pasting surface is formed around an outer edge of the lower end of the pasting die-head, so that a groove is formed at an interior of the lower end of the pasting die-head.

9. The adhesive pasting method for lithium ion battery pole piece according to claim 1, wherein the closed and raised pasting surface and a bottom surface of the pole piece cavity are planes or complementary curved surfaces.

10. The adhesive pasting method for lithium ion battery pole piece according to claim 1, wherein a plurality of pole piece tab retaining slots are disposed at a lateral area of the pole piece cavity.

11. The adhesive pasting method for lithium ion battery pole piece according to claim 1, wherein the closed and raised pasting surface are equal or unequal in width.

12. The adhesive pasting method for lithium ion battery pole piece according to claim 11, wherein when the closed and raised pasting surface has equal widths, an inner and outer contour of the closed and raised pasting surface is square, rectangular, rhombic, triangular, circular, elliptical, star-shaped, heart-shaped, pentagonal, or D-shaped.

13. The adhesive pasting method for lithium ion battery pole piece according to claim 11, wherein when the closed and raised pasting surface has unequal widths, an inner contour and an outer contour of the closed and raised pasting surface are rectangular and square, square and rectangular, circular and square, elliptical and rectangular, elliptical and circular, or circular and elliptical, respectively.

14. The adhesive pasting method for lithium ion battery pole piece according to claim 1, wherein a heating temperature of the heating element ranges from 40° C. to 400° C.

15. The adhesive pasting method for lithium ion battery pole piece according to claim 1, wherein the driver is a gas cylinder, a screw motor, a servo motor, or a stepper motor.

16. An adhesive pasting method for lithium ion battery pole piece, an adhesive pasting machine using the adhesive pasting method comprising a pole piece bottom die; a pasting die-head; a controller; a rack; and a driver,
wherein the rack comprises a rack platform and a pedestal, the pole piece bottom die is disposed in a bottom of the pedestal, the pasting die-head is disposed in an upper part of the pedestal and driven by the driver, the controller is disposed on the rack platform and electrically connected to the driver,
the pole piece bottom die has a pole piece cavity configured to hold and position a pole piece, a lower part of the pasting die-head matches with the pole piece cavity so that a lower end of the pasting die-head is embedded into the pole piece cavity, a surface of the lower end of the pasting die-head has a closed and raised pasting surface, and the pasting die-head comprises a heating element electrically connected to the controller,
the adhesive pasting machine further comprises two or more pole piece bottom dies disposed on a movable platform at the bottom part of the pedestal, and the movable platform is electrically connected to the controller and performs under instructions of the controller translational movements or rotational movements, so that each of the pole piece bottom dies is moved around between a pasting station and a material loading station, and
the adhesive pasting method comprising the steps of:
(a) putting a hot melt adhesive ring in the pole piece cavity;
(b) disposing a surface of a lithium ion battery pole piece with a paste composition downward so that the paste composition of the lithium ion battery pole piece corresponds to a hollow part of the hot melt adhesive ring and that a lateral side of the surface of the lithium ion battery pole piece without any paste composition corresponds to an upper part of the hot melt adhesive ring;
(c) switching on the heating element to heat the pasting die-head to a pre-set temperature;
(d) switching on the driver to drive the pasting die-head to move downward until the closed and raised pasting surface of the pasting die-head presses against the lithium ion battery pole piece, thus causing the heated pasting die-head to melt an exterior surface of the hot melt adhesive ring and allowing the hot melt adhesive ring to adhere to the lithium ion battery pole piece;
(e) the driver driving the pasting die-head to separate from the pole piece bottom die to obtain a lithium ion battery pole piece with the hot melt adhesive ring attached thereto;
(f) the movable platform switching the pasting station and the material loading station; and
(g) repeating Steps (a), (b), and (d) through (f).

17. The adhesive pasting method for lithium ion battery pole piece according to claim 16, Steps (d) and (e) are replaced by the steps of:
(d′) switching on the driver to drive the pole piece bottom die to move upward until the lithium ion battery pole piece presses against the closed and raised pasting surface of the pasting die-head, thus causing the heated pasting die-head to melt an exterior surface of the hot melt adhesive ring and allowing the hot melt adhesive ring to adhere to the lithium ion battery pole piece; and
(e′) the driver driving the pole piece bottom die to separate from the pasting die-head to obtain a lithium ion battery pole piece with the hot melt adhesive ring attached thereto.

18. The adhesive pasting method for lithium ion battery pole piece according to claim 16, wherein the adhesive pasting machine includes two drivers configured to drive the pole piece bottom die and the pasting die-head respectively, and Steps (d) and (e) are replaced by the steps of:
(d″) switching on the driver to simultaneously drive the pasting die-head and the pole piece bottom die to move toward each other until the lithium ion battery pole piece presses against the closed and raised pasting surface of the pasting die-head, thus causing the heated pasting die-head to melt an exterior surface of the hot melt adhesive ring and allowing the hot melt adhesive ring to adhere to the lithium ion battery pole piece; and
(e″) the driver driving the pasting die-head to separate from the pole piece bottom die to obtain a lithium ion battery pole piece with the hot melt adhesive ring attached thereto.

19. The adhesive pasting method for lithium ion battery pole piece according to claim 16, wherein the pasting die-head further comprises a plurality of heating elements electrically connected to the controller.

20. The adhesive pasting method for lithium ion battery pole piece according to claim 16, wherein the closed and raised pasting surface is formed around an outer edge of the lower end of the pasting die-head, so that a groove is formed at an interior of the lower end of the pasting die-head.
